(19) United States
(12) Patent Application Publication
(10) Pub. No.: US 2009/0033989 A1
(43) Pub. Date: Feb. 5, 2009

(54) IMAGE FORMING SYSTEM AND PRINT DATA GENERATING METHOD

(75) Inventor: Chiharu Yumoto, Sodegaura-shi (JP)

Correspondence Address: PATENTTM.US, P. O. BOX 82788, PORTLAND, OR, 97282-0788, US

(73) Assignee: CANON FINETECH INC., Misato-shi (JP)

(21) Appl. No.: 12/179,641

(22) Filed: Jul. 25, 2008

(30) Foreign Application Priority Data
Jul. 30, 2007 (JP) 2007-197313

(51) Int. Cl. G06F 3/12

(52) U.S. Cl. 358/1.15

(57) ABSTRACT

An image forming system generates print data according to a predetermined layout based on a database (401) in which a plurality of data records are stored and based on images associated with respective data records wherein the print data includes the image data. The database stores a keyword, which identifies image data corresponding to each of the plurality of data records, as one data item. When the plurality of data records of the database are printed, the image data corresponding to the keyword of each data record is searched for and read from a storage unit in which the image data is stored and the print data is generated according to the predetermined layout. When print data that includes image data is generated, this configuration of the image forming system allows the user to generate print data without giving a heavy load on the user even when image data is moved.

### DETAILED DESCRIPTION

1. Field of the Invention

The present invention relates to an image formation system and a print data generating method that read a database for referencing its content to print plural records of data in which each record includes an image.

2. Description of the Related Art

Conventionally, when plural records of data each including a plurality of data items are read from a database for printing according to a predetermined layout, data is put into areas of the layout for generating the print s data. In this case, when there is a need for printing an image associated with each record, in the same layout, it is necessary to read the image data corresponding to the record. To allow a user to specify an image file corresponding to a record in the database, the file specification information, that is, the full path of a file, is described in each record in the database.

As a technology for pasting an image in a document for printing, Japanese Patent Laid-Open Publication No. Hei 8-190636 discloses a technology that the user specifies a document, in which an image is to be pasted, and a merge definition file at a print time to allow an image to be merged for printing according to the content of the definition file.

When the file specification information, which is specified by a full path, is described in each data unit (record) in the database, the problem is that, when layout-defined print data is moved from the device to another device, the path name of the file in which the image is stored is changed and, therefore, an extra work is needed to change the full path specification information in the database.

When separate image data is assigned to each record in the database, the technology described in Japanese Patent Laid-Open Publication No. Hei 8-190636 requires the user to execute the procedure for selecting an image file from a displayed image file list in order to specify an image file for each document for pasting an individual image in the document. When a lot of records are read from the database for printing, the execution of this procedure puts a heavy load on the user.

### SUMMARY OF THE INVENTION

In view of the foregoing, it is an object of the present invention to provide an image forming system and a print data generating method that, when print data that includes image data is generated, allow the user to generate print data without giving a heavy load on the user even when image data is moved.

An image forming system of the present invention generates print data according to a predetermined layout based on a database, in which a plurality of data records each including a plurality of data items are stored, and based on images associated with respective data records, the print data including the image data, wherein the database stores a keyword as one data item, the keyword identifying image data corresponding to each of the plurality of data records and, when the plurality of data records of the database are printed, the image data corresponding to the keyword of each data record is searched for and read from a storage unit in which the image data is stored and the print data is generated according to the predetermined layout.

Including a keyword, which identifies image data for each data record in the database, allows the user to search for image data based on the keyword, making it possible to find image data for each data record without specifying a full path.

The image forming system may comprise a folder specification unit that receives a specification of a folder to be searched when the image data is searched for from the storage unit wherein image data in the specified folder is searched using the keyword.

In addition, the image forming system may comprise an image format specification unit that receives a specification of an image format of the image data wherein image data with the specified image format is searched.

A file name without an extension of the image data, may be used as the keyword.

Another image forming system of the present invention generates print data according to a predetermined layout based on a database, in which a plurality of data records each including a plurality of data items are stored, and based on images associated with respective data records, the print data including the image data, wherein the database is at least one of a database in which a keyword identifying image data corresponding to each of the plurality of data records is stored and a database in which file specification information specifying a full path of image data corresponding to each data record is stored, the image forming system comprising a screen presentation unit that presents a user interface screen to allow the user to select one of a search key specification method, in which a keyword is specified for each data record in the database to identify image data, and a full path specification method in which a full path is specified to identify image data; and a print data generation unit that, when the plurality of data records of the database are printed, generates print data according to the predetermined layout either by searching a storage unit, in which image data is stored, for image data corresponding to the keyword of each data record if the search key specification method is selected or by reading the specified image data according to the file specification information if the full path specification method is selected.

In this configuration, the user can selectively use the search key specification method or the full path specification method according to a data base corresponding to the image specification method.

When print data including image data is generated, the method according to the present invention can identify image data according to a keyword included in the database even when image data is moved. Therefore, unlike the conventional full path specification method in which the full path specification information must be changed, the method of the present invention can generate print data without giving a heavy load on the user.

In addition, the search key specification method of the present invention may be combined with the conventional full path specification method so that the user can select one of them. This combination allows the user to generate print data appropriately in a method suitable for the user environment.

### BRIEF DESCRIPTION OF THE DRAWINGS

FIG. 1 is a diagram showing the general configuration of an image forming system of the present invention.

FIG. 2 is a diagram showing the conventional method in which a database, where image file names are described by full paths, is read for generating print data.

FIG. 3 is a diagram showing an example of the general process of printing data from a database.

FIG. 4 is a diagram showing the search key specification method in an embodiment of the present invention.

FIG. 5 is a diagram showing the image search method in the search key specification method of the present invention.

FIG. 6 is a diagram showing an example of the user interface screen used in the search key specification method.

FIG. 7 is a diagram showing another example of the keyword in the database in the embodiment of the present invention.

FIG. 8 is a flowchart showing an example of merge print processing in the image forming system in the embodiment of the present invention.

### DETAILED DESCRIPTION OF PREFERRED EMBODIMENTS

An embodiment of the present invention will be described below in detail with reference to the drawings.

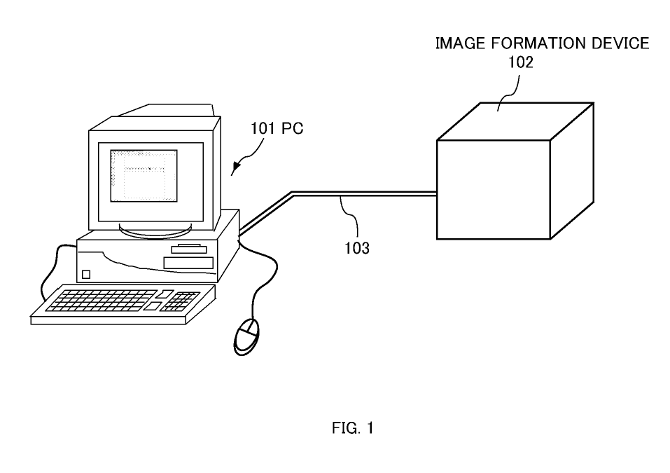

FIG. 1 is a diagram showing the general configuration of an image forming system of the present invention. A personal computer (hereinafter called a PC) 101, an information processing device for printing the content of a database according to the present invention, is connected to an image formation device 102 via a communication interface 103. The available communication interface 103 may be any communication interface such as a network, a USB, and a wireless LAN. The image formation device 102 is a printer that employs any recording method (inkjet recording method, a laser recording method, etc.).

The PC 101 has a merge application 104 installed that reads print data, generated based on a database, into the PC and sequentially prints the content of the database. This application generates merge data and sends it to the image formation device 102. The image formation device 102 receives the merge data and prints data for each data unit (record) of the database. Any type of database, such as a CSV, XML, tab-separated text format, XLS, and ACCESS format database, may be used.

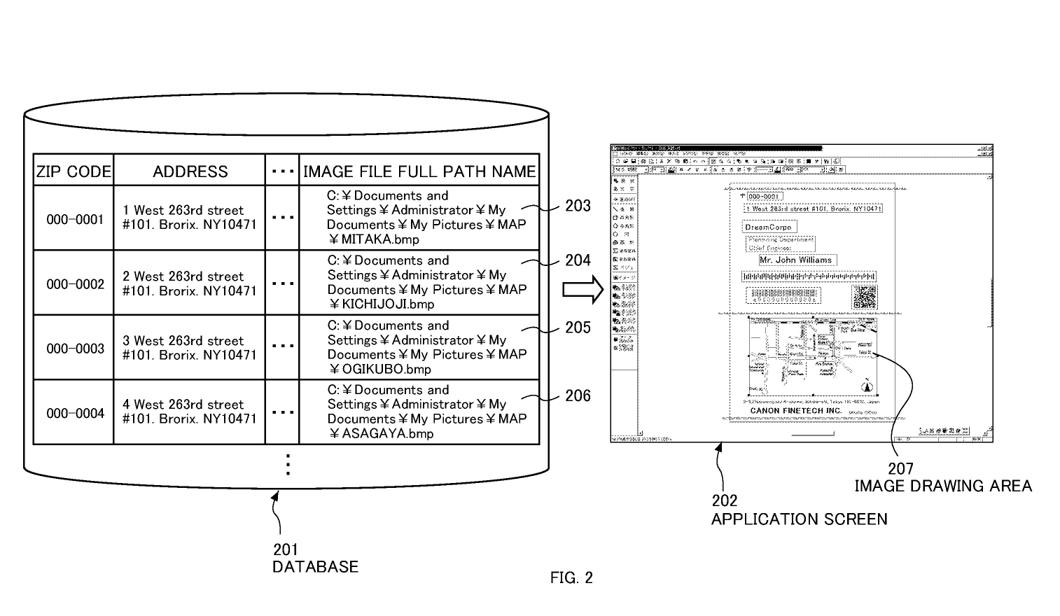

FIG. 2 is a diagram showing the conventional method in which a database, where image file names are described by full paths, is read for generating print data. In the example of the database shown in the figure, a plurality of records 203-206 are stored, each including multiple data items such as a ZIP code, an address, and a company name, as well as the full path name of an image file corresponding to the record. A full path name is identification information that, when a data file is stored in the hierarchical storage structure, specifies the hierarchical position of the file from the top to that file. The full path name is terminated with the file name. In the example in the figure, the first part C: of “C:¥Documents and Settings¥Administrator¥My Documents¥My Picture¥MAP¥MITAKA.bmp” indicates the drive name of the storage device, “Documents and Settings”, “Administrator”, “My Documents”, and so on that follow the drive name indicate hierarchical folder names, and the last part “MITAKA.bmp” indicates the file name. The “bmp” that follows the dot of the file name is an extension indicating the type of the file (bitmap image format in this example).

Although not shown in FIG. 2, the actual data of an image file specified by a full path name is stored separately in a storage unit. In this embodiment, the image file format of image data is not limited to a particular format but any file format such as the bitmap (BMP) format, TIFF format, JPEG format, GIF format, and PS format may be used.

The PC 101 starts the merge application in response to a user operation and reads a database 201. In this case, the content of one record (first page) of the database is displayed on an application screen 202 in the specified layout. The merge application reads the image file, specified by the full path, for each record in the database, and draws the content of the image file for the record in an image drawing area 207. This display allows the user to pre-view the print result. The method, in which print data is generated using a database where the path of an image file is stored in the full path as in the database 201, is called a full path specification method.

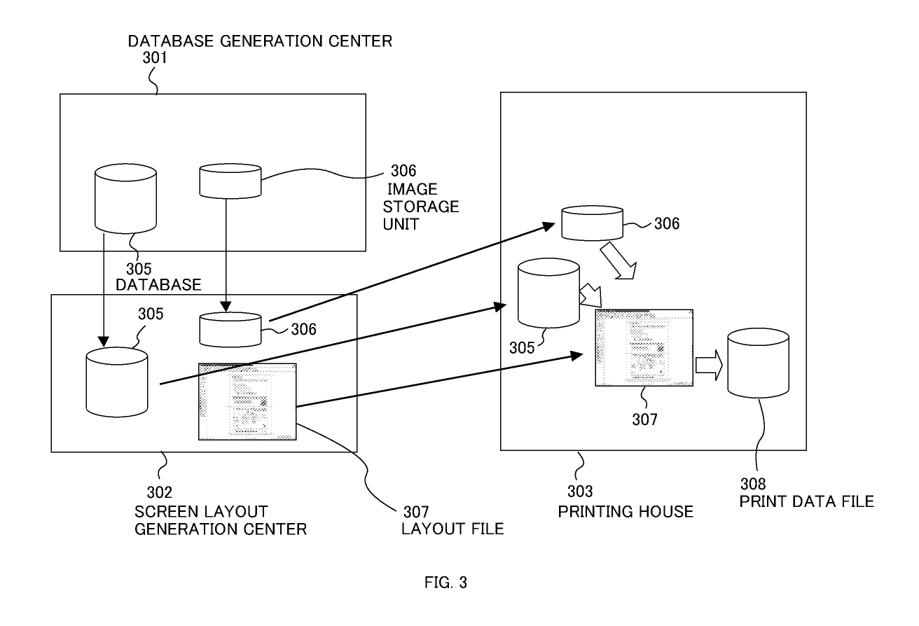

FIG. 3 is a diagram showing an example of the process of printing data from a database. In some case, for example, when a large amount of direct mail is printed, the process of printing data from a database is performed at a plurality of locations, for example, in three centers including a database generation center 301, a screen layout generation center 302, and a printing house 303. The image forming system of the present invention refers narrowly to the device configuration of the printing house 303 but broadly to the device configuration including not only the printing house 303 but also the screen layout generation center 302 and/or the database generation center 301.

The database generation center 301 is a facility where the content (text data) of a database 305 used for printing and the content (image data) of an image storage unit 306 used for printing are generated (created).

The screen layout generation center 302 generates a layout file 307 used for printing while referencing the database 305, generated in the database generation center 301, and the image storage unit 306.

The layout file 307 generated in the screen layout generation center 302 is moved to the printing house 303. The layout file 307 may be moved either by communication means such as a communication network or by transporting a portable recording medium in which the layout file 307 is saved. The printing house 303 generates a print data file 308 and prints it by using the content of the database 305, the content of the image storage unit 306, and the layout file 307. The printing house 303 corresponds to the PC 101 and the image formation device 102 shown in FIG. 1.

In a configuration where the database generation location and the print data generation location are different as described above, the full path specification method, which requires that the image data arrangement position be fixed, sometimes affects the operability. In the full path specification method, a change in the image data arrangement involves a change in the path name as described above, thus requiring the user to change all full path names in the database.

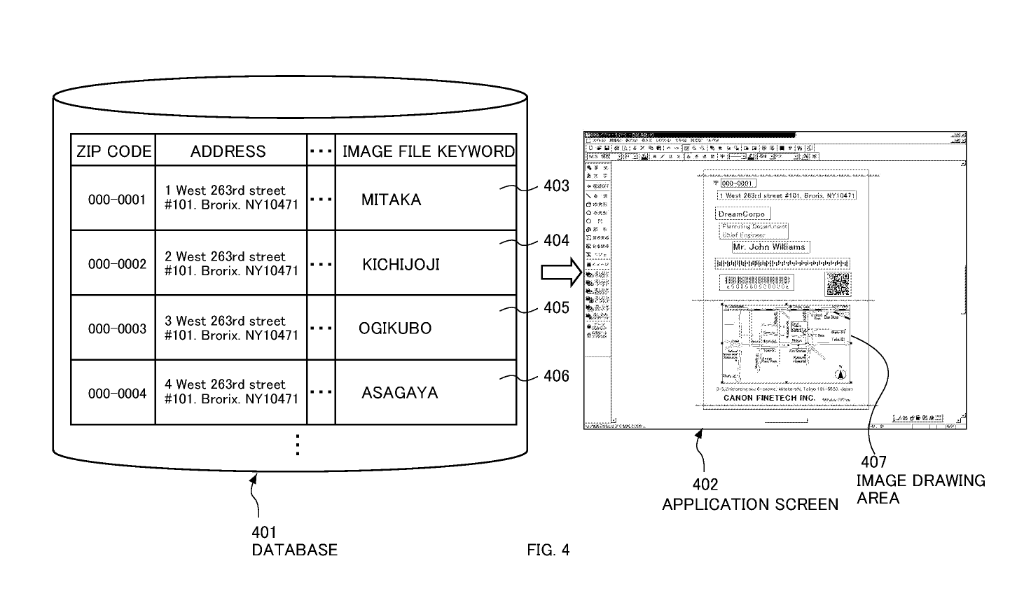

FIG. 4 is a diagram showing the search key specification method in the embodiment of the present invention. In the search key specification method, a database 401 is prepared in which a keyword specifying an image file (“image file keyword”) is included as one data item in each of plural records 403-406, and data is read from this database before generating the print data. The image file in this example is similar to the image file shown in FIG. 2, but the file name (not including the extension) of an image file is used as the image file keyword.

In this case, the merge application reads the content of the database 401 and performs the data merge processing for each record in the same manner as in the example described above but identifies an image file in a manner different from that described in the example above. That is, the application searches for an image file based on the image file keyword and reads the image file that is searched for. An application screen 402 and an image drawing area 407 in this case are the same as the application screen 202 and the image drawing area 207 shown in FIG. 2.

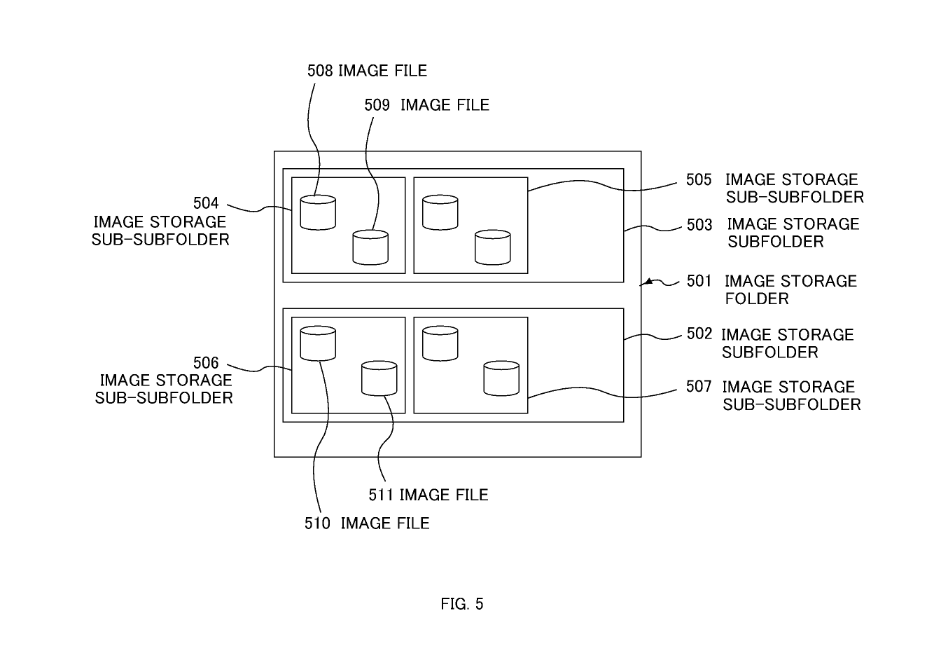

The following describes the image search method in the search key specification method of the present invention with reference to FIG. 5.

In the storage device in which image data is stored, image storage subfolders 502 and 503 are stored in an image storage folder 501. Image storage sub-subfolders 504, 505, 506, and 507 are stored in the image storage subfolders 502 and 503, and image files 508-511 used for printing are stored in the image storage sub-subfolders 504, 505, 506, and 507. In this way, the image files are usually stored in the hierarchical storage structure in the storage device. This means that a full path name must be specified correctly in the full path specification method in order to identify an image file. However, when image data is moved to another storage device, the full path name stored in each record in the database must be changed in the full path specification method.

In contrast, in the search key specification method of the present invention, it is only required that a unique keyword be assigned to each image file at least in the search range of the image files and that the keyword be described in the database. This configuration allows an image file to be found and read using the keyword even if the storage location of the image file is changed.

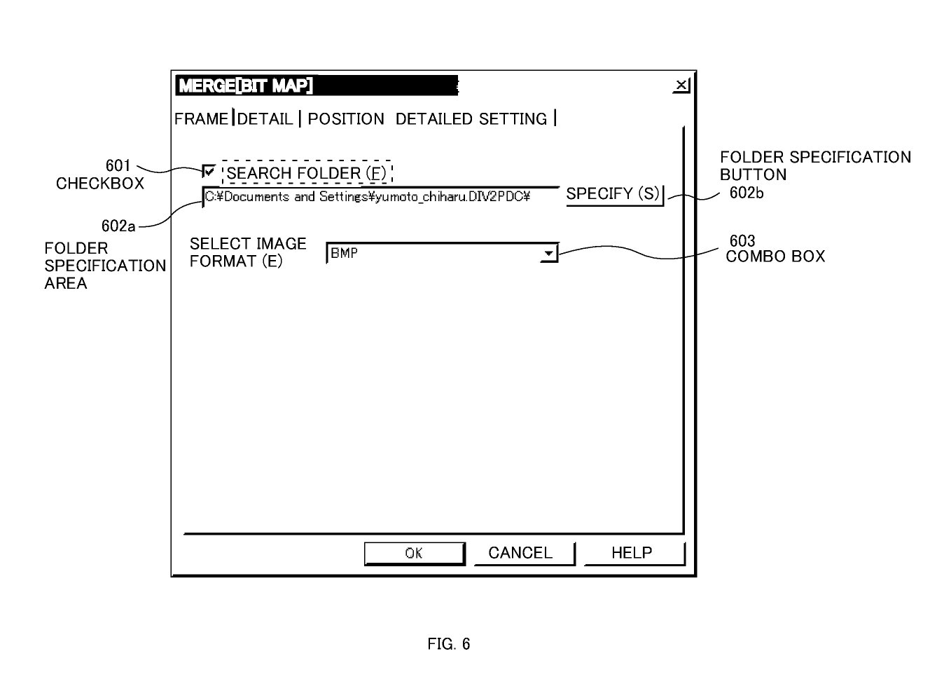

FIG. 6 is a diagram showing an example of the user interface screen used by the search key specification method. In general, the broader the search range of the file search is, the longer it takes for the search. So, if the location (for example, a folder) in which the desired image file is stored is known, the user can specify the location to reduce the time required for the search. For this reason, a folder specification area 602a and a folder specification button 602b are provided on the screen for specifying a folder. Similarly, if the image format (extension) of a file to be searched for is known, the user can specify the image format to reduce the time required for the search. For this reason, a combo box 603 is provided on the screen to allow the user to select the image format.

Although the folder location and the image format, if specified, reduce the time, the search key method still requires a longer time than the full path specification method. So, to allow the user to select between the search key specification method and the conventional full path specification method as necessary, a checkbox 601 is also provided on the screen so that the user can check “Search folder”. The user can determine whether to check (turn on) this checkbox depending upon to which specification method the database to be used corresponds.

When the user checks the checkbox 601, the user is also required to specify the folder in which the desired image is stored. To do so, the user presses the folder specification button 602b to display the directory and selects a folder from the directory to specify the folder using the folder specification area 602a (or enter the folder name, including the path name, in the folder specification area 602a).

When the search key specification method is selected, the application searches the folder, selected in the image storage folder specification area 602a, for the image file and generates print data. File names without extensions are described in the database. The application searches the folder, specified in the image storage folder specification area 602a, for the image file corresponding to the keyword specified in the database and the extension selected in the image format selection combo box 603. For example, if a record in the database contains the keyword “MITAKA”, the folder “C:¥Documents and Settings¥Administrator¥My Documents¥My Pictures¥MAP” is selected in the folder specification area 602a, and “BMP” is selected in the image format selection combo box 603, the image file “C:¥Documents and Settings ¥Administrator¥My Documents¥My Pictures¥MAP¥MITAKA.bmp” is extracted as a result of the image data search.

When the selection checkbox 601 in the search key specification method is off, the image file specified by the full path specification method is read, and print data is generated, as in the conventional system.

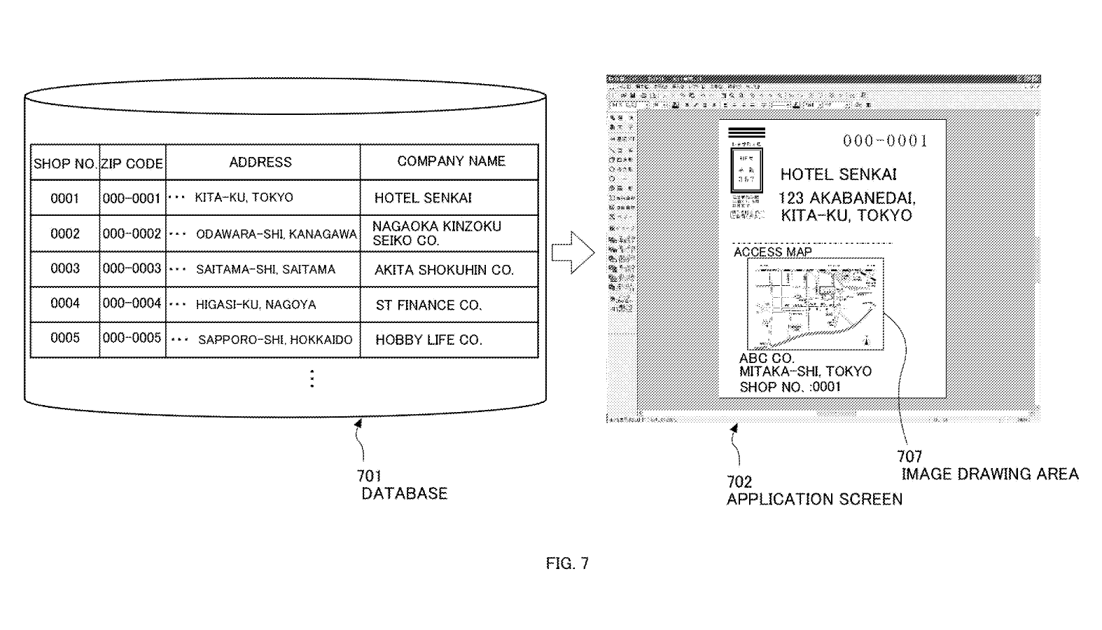

FIG. 7 is a diagram showing another example of a keyword used in the database in the embodiment of the present invention. In this database 701, a specific name is not used for identifying an image file, but an existing data item is selected from the database and the data of this data item is used as the keyword. This data item is an item that can be associated with an image file and, in this example, a “shop number” is selected as the keyword which is used as the file name of the image data. As a result, the application can search for the image file corresponding to each record with the shop number as the keyword. An application screen 702 shown in the figure shows an example of the printing of direct mail addresses. In the example in the figure, the “shop number” is displayed on the application screen 402 as one of data items. Although the shop number must be a unique number in each record, the same shop number may be assigned to different records. In the example, the map of a shop is displayed in an image drawing area 707.

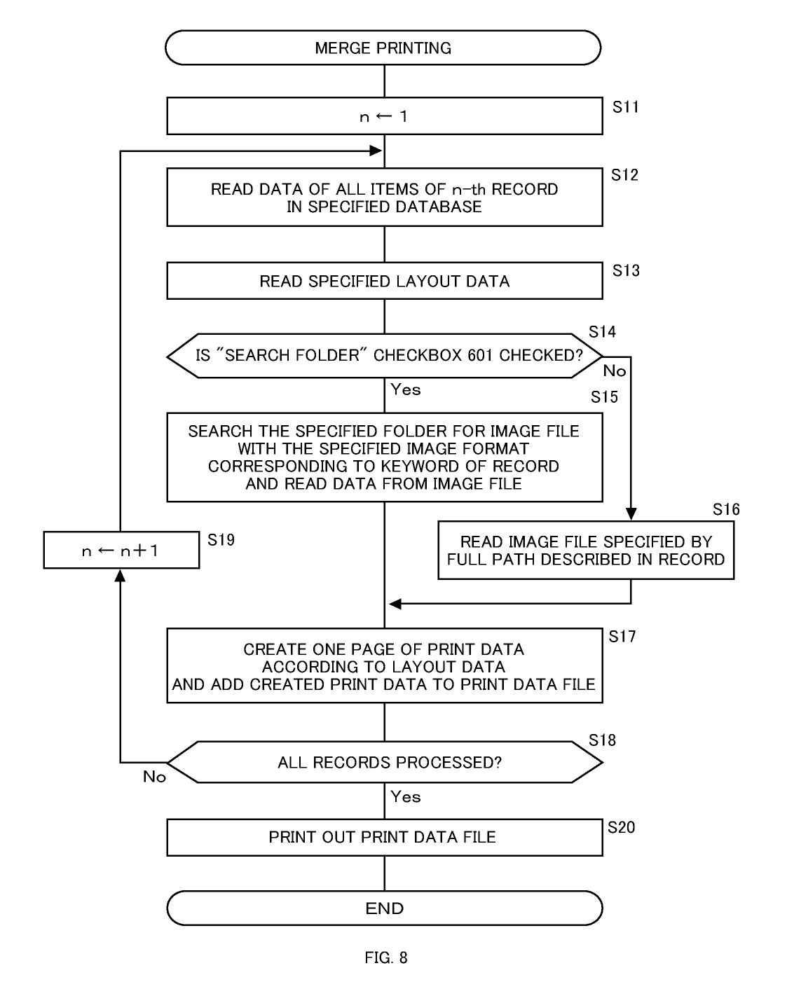

FIG. 8 is a flowchart showing an example of merge print processing in the image forming system in this embodiment. This processing is implemented when the CPU in the PC 101 shown in FIG. 1 interprets and executes the program stored in the storage unit (memory, etc.).

First, the PC initializes the variable n that specifies a record in the database (1 is assigned in the figure) (S11). After that, the data of all items of the n-th record of the specified database is read (S12). Next, the specified layout data is read (S13). A check is made if the “Search folder” checkbox 601 is checked (S14). If the checkbox is not checked, the image file specified by the full path in the record is read as in the conventional method (S16). If the checkbox is checked, the image file corresponding to the keyword of the record and in the specified image format is searched for from the specified folder and the data is read from the image file (S15).

After that, one page of print data is created according to the layout data and the created print data is added to the print data file (S17).

The variable n is incremented (S19) and control is passed back to S12 to repeat the processing described above until the processing is performed for all records, which are to be printed, in the specified database (S18).

After the processing for all records is finished, the print data file is sent to the image formation device 102 for printout (S20).

While the preferred embodiment of the present invention has been described, it will be understood that the present invention is not limited to the embodiment described above but various modifications and changes could be made. For example, though the user can selectively use the conventional full path specification method and the search key specification method of the present invention in the example shown in FIG. 8, the search key specification method may also be used singly. In that case, the checkbox 601 on the interface screen in FIG. 6 is not necessary.

What is claimed is:

1. An image forming system that generates print data according to a predetermined layout based on a database, in which a plurality of data records each including a plurality of data items are stored, and based on images associated with respective data records, said print data including the image data, wherein
said database stores a keyword as one data item, said keyword identifying image data corresponding to each of the plurality of data records, and
when the plurality of data records of said database are printed, the image data corresponding to the keyword of each data record is searched for and read from a storage unit in which the image data is stored and the print data is generated according to the predetermined layout.

2. The image forming system according to claim 1, comprising a folder specification unit that receives a specification of a folder to be searched when the image data is searched for from said storage unit wherein image data in the specified folder is searched using the keyword.

3. The image forming system according to claim 1, comprising an image format specification unit that receives a specification of an image format of the image data wherein image data with the specified image format is searched.

4. The image forming system according to claim 1 wherein a file name without an extension of the image data, is used as the keyword.

5. The image forming system according to claim 2 wherein a file name without an extension of the image data, is used as the keyword.

6. The image forming system according to claim 3 wherein a file name without an extension of the image data, is used as the keyword.

7. An image forming system that generates print data according to a predetermined layout based on a database, in which a plurality of data records each including a plurality of data items are stored, and based on images associated with respective data records, said print data including the image data, wherein
said database is at least one of a database in which a keyword identifying image data corresponding to each of the plurality of data records is stored and a database in which file specification information specifying a full path of image data corresponding to each data record is stored, said image forming system comprising:
a screen presentation unit that presents a user interface screen to allow a user to select one of a search key specification method, in which a keyword is specified for each data record in the database to identify image data, and a full path specification method in which a file is specified by a full path to identify image data; and
a print data generation unit that, when the plurality of data records of said database are printed, generates print data according to the predetermined layout either by searching a storage unit, in which image data is stored, for image data corresponding to the keyword of each data record if the search key specification method is selected or by reading the specified image data according to the file specification information if the full path specification method is selected.

8. The image forming system according to claim 7, further comprising a folder specification unit that receives a specification of a folder to be searched when said storage unit is searched for image data wherein image data in the specified folder is searched using the keyword.

9. The image forming system according to claim 7, further comprising an image format specification unit that receives a specification of an image format of image data wherein image data with the specified image format is searched.

10. The image forming system according to claim 7 wherein a file name without an extension of the image data, is used as the keyword.

11. The image forming system according to claim 8 wherein a file name without an extension of the image data, is used as the keyword.

12. The image forming system according to claim 9 wherein a file name without an extension of the image data, is used as the keyword.

13. A print data generating method that generates print data according to a predetermined layout based on a database, in which a plurality of data records each including a plurality of data items are stored, and based on images associated with respective data records, said print data including the image data, said print data generating method comprising the steps of:
when said database is built, storing a keyword, which identifies image data corresponding to each of said plurality of data records, as one data item of the data record;
when the plurality of data records in said database are printed, searching a storage unit, in which image data is stored, for image data corresponding to a keyword of each data record and reading the image data; and
generating print data according to the predetermined layout based on the image data that is read and on a content of said database.

14. The print data generating method according to claim 13, further comprising the steps of receiving a specification of a folder to be searched when said storage unit is searched for image data; and searching image data in the specified folder using the keyword.

15. The print data generating method according to claim 13, further comprising the steps of receiving a specification of an image format of image data; and searching image data with the specified image format.

16. The print data generating method according to claim 13 wherein a file name without an extension of the image data, is used as the keyword.

17. The print data generating method according to claim 14 wherein a file name without an extension of the image data, is used as the keyword.

18. The print data generating method according to claim 15 wherein a file name without an extension of the image data, is used as the keyword.
